(19) United States
(12) Patent Application Publication
(10) Pub. No.: US 2014/0371927 A1
(43) Pub. Date: Dec. 18, 2014

(54) HARDSCAPE TORCH

(71) Applicant: FREDDIE POOLE'S MARTIAL FITNESS, LLC, Dallas, TX (US)

(72) Inventors: Fareburz Frederick Pooladsanj, Dallas, TX (US); Brandi Lynn Pierce, Dallas, TX (US)

(21) Appl. No.: 14/370,705

(22) PCT Filed: Jan. 3, 2013
(86) PCT No.: PCT/US13/20140

§ 371 Date: Jul. 3, 2014

Related U.S. Application Data
(60) Provisional application No. 61/582,752, filed on Jan. 3, 2012.

(51) Int. Cl. F21S 13/12; G05D 7/06; F21V 37/00

(52) U.S. Cl. CPC F21S 13/12; F21V 37/0008; G05D 7/0617
USPC 700/282; 362/181

(57) ABSTRACT

Systems, methods, and articles of manufacture are provided for one or more hardscape torches that can be safely and conveniently operated as well provide ambience and lighting to any setting. Certain embodiments of the present invention provide extra functionality to such a hardscape torch, for example, so that any such torch can be controlled or utilized remotely or through home automation or similar systems (e.g., via timers, sensors, wireless interfaces, and/or programmable settings).

### CROSS-REFERENCE TO RELATED APPLICATIONS

The present invention claims benefit to U.S. provisional patent application Ser. No. 61/582,752 filed Jan. 3, 2012, the entire contents of which are incorporated by reference.

### FIELD OF THE INVENTION

This invention relates generally to combustion devices, and relates more particularly to torches, such as Tiki torches and/or hardscape torches.

### BACKGROUND OF THE INVENTION

Tiki torches are used throughout the world for night lighting or decoration. Often, the torches are mounted on the end of poles, which are stuck into the ground. Tiki torches are traditionally wick and oil open flame torches made of bamboo or cane. Modern torches use electricity or other methods to provide light. They are also made of nontraditional materials such as metal. Some models even incorporate citronella to deter mosquitoes.

Tiki torches are popular lighting elements. While they have become permanent fixtures in patios, backyards, and decks around the United States, their history has remained a mystery. Tiki torches have their origins in Polynesian culture, art, and myth. The name Tiki comes from the Polynesian human creation myth in which Tiki was the Polynesian equivalent of Christianity's Adam. Tiki also refers to wooden carvings meant to represent the gods, and this is likely why torches sometimes feature carved wooden faces.

Tiki torches are available in a variety of materials, from traditional bamboo to more modern copper or steel. There are also propane Tiki torches and solar Tiki torches that flicker like live flames. They are a fun way to add ambience to a patio or deck, but they are not without hazards.

Being top heavy, however, they can tip or sway in strong wind and can therefore cause fire injury and damage. Accordingly, there exists a need for a Tiki torch-type device that is capable of safely and conveniently providing ambience and lighting, while also maintaining their portable nature, but without the hazards (e.g., being top heavy).

It would, therefore, be advantageous to provide a new type of Tiki torch, referred to as a hardscape torch, that incorporates the best of all previous products and improves upon them. Such a hardscape torch would allow a user to safely and conveniently operate such a device as well as provide ambience and lighting to any setting.

In addition, it would be advantageous to provide extra functionality to such a Tiki torch so it can be controlled or utilized remotely or through home automation system(s) (e.g., via timers, sensors, and/or programmable settings). This feature would be useful for users with homes with computer functionality or advanced electronic equipment, so users who move from location to location either in their home, office, or on a trip can control their hardscape torch or network of hardscape torches.

### SUMMARY OF THE INVENTION

Hardscape torches, as well as methods and systems of using hardscape torches, are provided. In one embodiment, the hardscape torch can include a stone or rock base and a recessed fuel canister for supplying fuel to a flame, wherein the recessed fuel canister is located within the stone or rock base, such that when inserted into the base, the recessed fuel canister does not protrude from the surface of the base. The stone or rock base can be real or faux material and can be ceramic, masonry, cement, fiberboard, fiberglass, plastic, or metal.

In another embodiment, the hardscape torch can include a stone or rock tabletop base and a recessed fuel canister for supplying fuel to a flame, wherein the recessed fuel canister is located within the stone or rock base.

In certain embodiments, the hardscape torch is configured to interact with a system (e.g., a home automation system), or operate independently, and further includes other components such as timers, sensors, wireless interfaces, or programmable settings. For example, the system can include a personal computing device, a server, a network, and a plurality of hardscape torches each of which comprising a stone or rock base, and a recessed fuel canister for supplying fuel to a flame, wherein the recessed fuel canister is located within the stone or rock base. In another example, the system can include a personal computing device, and a plurality of hardscape torches each being coupled to a network and comprising a stone or rock base, and a recessed fuel canister located within the stone or rock base for supplying fuel to a flame, wherein the plurality of hardscape torches are controllable by the personal computing device through the network.

In embodiments, a method of using a hardscape torch with a networked system (e.g., a home automation system) is provided. The method includes the steps of: configuring the system to operate the hardscape torch; igniting the hardscape torch through operation of the system; and shutting off the hardscape torch through operation of the system.

Other benefits and features of the present invention may become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

The invention will be better understood from a reading of the following detailed description, taken in conjunction with the accompanying figures in the drawings in which:

FIG. 1 is a view of a hardscape torch according to certain embodiments of the present invention;

FIG. 2 is a view of a fuel canister that may be used in the hardscape torch of FIG. 1 according to certain embodiments of the present invention; and

FIG. 3 is a view of a system that may be used with one or more hardscape torches according to certain embodiments of the present invention.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as or if used herein, is defined as directly or indirectly connected in an electrical, mechanical, or other manner.

### DETAILED DESCRIPTION OF THE INVENTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

A hardscape torch may be a torch that is similar to a Tiki torch in that, as a Tiki torch lights up by flame, so too would a hardscape torch. A hardscape torch is, however, unique in that it is preferably more easily disposed, diverse, safe, fire resistant, maintenance-free, may be used year round, and is potentially more cost effective.

Unlike the Tiki torch, hardscape torch may be in the shape of a natural decorative element (such as a stone or a rock) that would be able to be placed anywhere, which means that there would not be a need for mounting or attachment methods for the torch. It may therefore require no skill whatsoever in placing or positioning it. At the same time, because of the shape and/or weight of its base (it is preferably bottom-heavy), it is stable enough to withstand wind, other weather conditions and natural elements, making it less prone to tipping or blowing over and causing potential fire or other damage than a Ticki torch. A hardscape torch may therefore be more stable than other torches, inconspicuous, and may easily blend with any landscape surrounding until it is lit. Once lit, the hardscape torch may give the illusion of a flaming stone, thus creating a new look that would be very unique and soothing. In one embodiment, the hardscape torch can be designed utilizing real stones or rocks, and in an alternative embodiment, the hardscape torch can be designed utilizing faux (or fake) material shaped as stones or rocks.

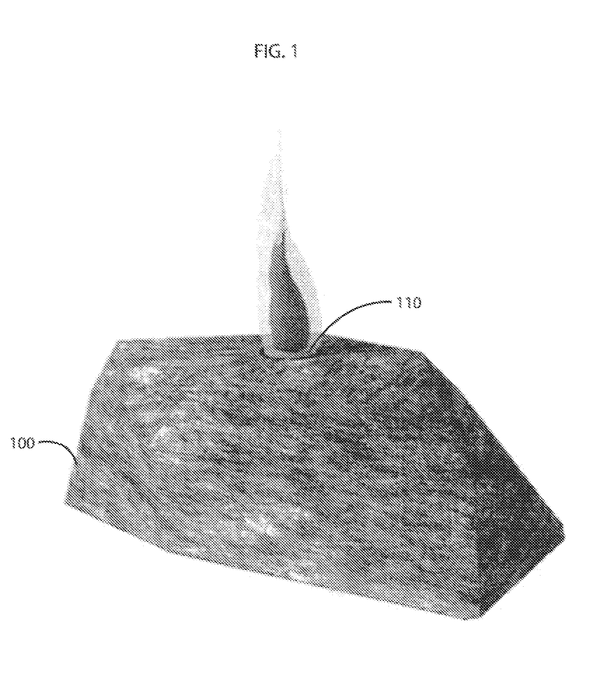

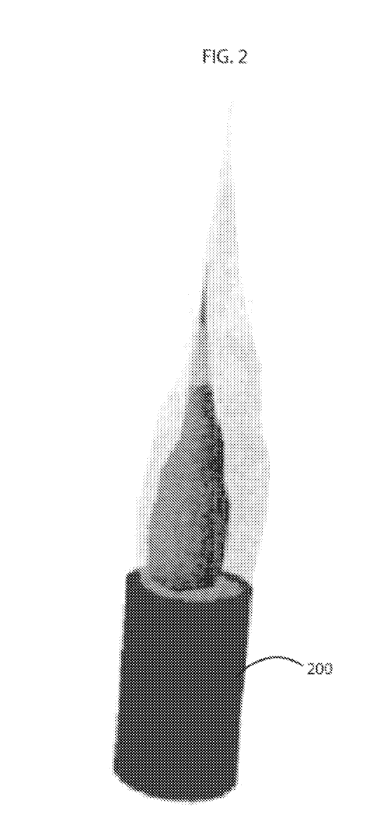

Similar to a common Tiki torch, hardscape torch may use a replaceable canister for fuel. The canister is preferably inserted and hidden beneath the surface of a base. An illustrative canister 200 and base 100 are shown in FIGS. 1 and 2. FIG. 1 depicts a base in the shape of a rock or stone. Other shapes are within the scope of the invention. FIG. 2 depicts a canister that has been removed from its base. A solar version of such a torch is also within the scope of the invention.

In certain embodiments of the present invention, the hardscape material of the base 100, as shown in FIG. 1, may be made of fire resistant and/or durable material. For example, it may be made out of ceramic, masonry, cement, fiberboard, fiberglass, plastic, metal (e.g., copper), etc. Further, the base may be made from real stones or rocks, and in an alternative embodiment, the base can be designed utilizing faux (or fake) materials. The base may be in the shape of a natural decorative element, such as a stone or rock, or it may be in the shape of a designed image. In alternative embodiments of the present invention, the base may be made out of material that is relatively more flammable, provided that a fire resistant coating is applied to its surface.

Different suitable fuels may be inserted in the canister such as oil, natural gas, propane, paraffin, ether, alcohol, or any other suitable fuel. An example of a type of oil that may be used is citronella oil, as it preferably repels insects or bugs such as mosquitoes. Other types of scented fuels or coatings with desirable characteristics may be used. For example, fuels or coatings that provide a desired color or colors to the flame may be used.

In one embodiment of the present invention, the hardscape torch includes a shut-off switch to shut off a fuel supply for the hardscape torch. In other embodiments, the shut-off switch is configured and arranged to shut off a fuel supply for the torch when the torch is tilted beyond a certain angle from vertical, such as between about twenty to about thirty degrees, or more specifically to about twenty five degrees (25°). This tilt angle may be varied as appropriate for a particular application. The shut-off switch may be positioned, for example, by or toward the fuel canister.

In another embodiment of the present invention, an igniter (known in the combustion art) may be provided for lighting the hardscape torch. The use of such igniters is known, and the details of their structure and operation are not provided herein. As an alternative to an igniter, the torch may be lit manually, such as by a match.

In yet another embodiment of the present invention, a shut-off switch to shut off a fuel supply for the hardscape torch and/or an igniter may be controlled remotely as discussed further below.

Alternatively, the hardscape torch may be hardwired to an electric or gas source. If the hardscape torch is hardwired to an electric source, the hardscape torch may contain switches and/or circuits to help control the flow of electricity to the hardscape torch. If the hardscape torch is hardwired to a gas source (e.g., propane or natural gas), the hardscape torch may contain safety control valves and/or switches to help control the flow of the gas to the hardscape torch.

These embodiments may be separate from or part of a home (or residence) automation system. For example, in one embodiment, one or more hardscape torches may be a part of a centralized lighting system, or other system, in a home automation system to provide improved convenience, comfort, energy efficiency, and security. Such a configuration would allow a user to conveniently operate the torches by allowing each torch to be controlled or utilized remotely through home automation (e.g., via timers, sensors, and/or programmable settings) whether individually, in groupings, or collectively. This feature would be useful for users with homes with computer functionality or advanced electronic equipment, so users who move from location to location either in their home, office, or on a trip can control their hardscape torch or torches. Thus, in certain embodiments, the hardscape torch or torches is/are configured to interact with a home automation system, or operate independently, and further include other components such as timers, sensors, wireless interfaces, or programmable settings. For example, the hardscape torch may be equipped with certain sensors, which allow it to light when the sensor(s) senses that someone or something has entered a room or specific area where the hardscape torch has been placed. In addition, the hardscape torch may also be equipped to work with a specialized remote or a universal remote. Alternatively, it may be controlled through a mobile application running on a portable device such as a smartphone or tablet.

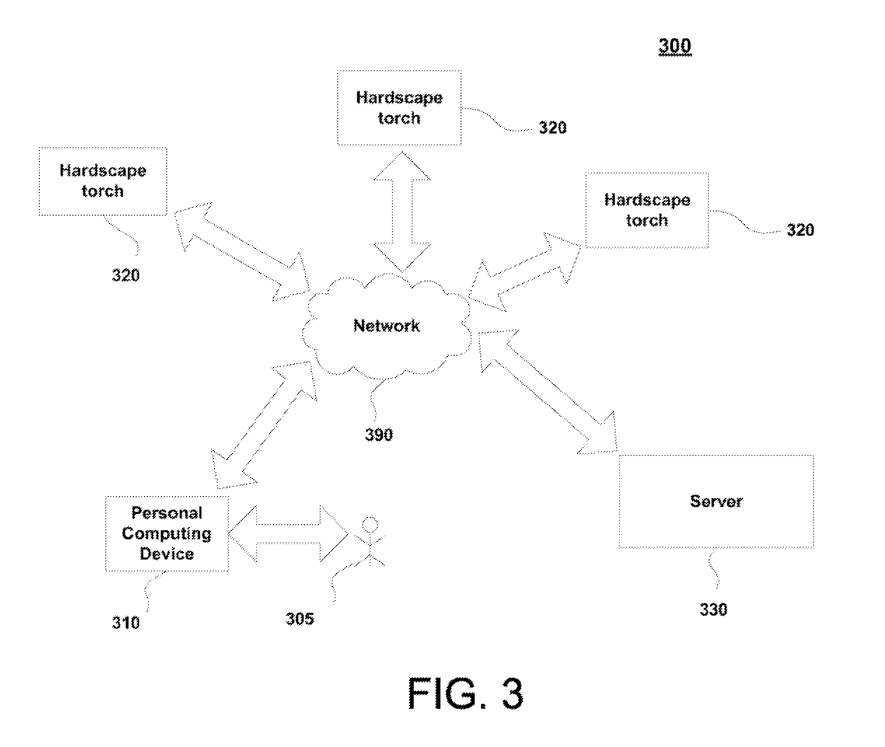

Further embodiments of the present invention include a network of torches that can be used in a public or commercial setting (e.g., hotels, resorts, theaters, museums, recreation centers, parks, malls etc.) as well as a residential setting. For example, they may be included in indoor or outdoor spaces of private homes or common spaces in residential buildings, or commercial or public environments, as well as any other venue where landscaping and hardscaping may intersect. These embodiments may be wirelessly or non-wirelessly interconnected to a centralized system like, for example, in FIG. 3.

An example of a system that includes or assists in controlling or operating a hardscape torch of the present invention is a home automation system, which includes one or more servers and one or more networks. Another example is a network of torches that are connected to a centralized control process, which may be located on the premises on a portable device or computer, or a remote server accessible via the Internet. Further, the network may be any type of network such as one that includes the Internet, a local area network (LAN), a wide area network (WAN), an intranet, etc. The server may generally represent any type of computing device. In certain embodiments, the server comprises one or more mainframe computing devices that execute a web server configured to communicate with personal computing devices over the Internet. A computer storage medium on the server may store applications or software code configured to provide assistance to users of or the home automation system in performing tasks related to launching, constructing, or modifying applications. Specifically, the server may be configured to provide applications to users via an interface displayed on personal computing devices. In certain embodiments, the methodology herein described can be based in part or controlled by remote control devices, personal computer(s), and/or mobile applications (for example, iPhone® apps, iPad® apps, Android® apps, and Microsoft® apps). The mobile applications may track application launches, relay launch information to networks, and/or import information to or from networks.

In another embodiment of the present invention, the hardscape torch may include the use of fire glass or other specially formulated jewel like glass crystals for use in fireplaces, fire pits, and gas fire pits. Alternatively, the hardscape torch may be battery or solar powered.

The base used for hardscape torch may be of any sizes, and may come in different shapes or shades. For example, it may be positioned on the ground as a large structure that is part of an exterior landscape. Depending on its size and weight (which is a factor of size and the material used for the base), hardscape torch may be laid flat on the desired surface, or may be attached to it (e.g., through screws and the like) if needed to provide more stability.

Alternatively, a tabletop version of such a torch is also within the scope of the invention. This tabletop version may simply rest on a table or include a base that may be attached through, for example, screws or other fastener. For example, the base 100, as shown in FIG. 1, may rest on a table.

As used herein, the term “fastener” means anything that fastens. Non-limiting examples of fasteners useful in an embodiment of the present invention include screws, bolts, zippers, velcro, buttons and corresponding button holes, and male and female snap buttons. Preferably the fastener is a screw.

In a further embodiment of the present invention, the hardscape torch may provide more aesthetic properties in that it may be more visually appealing and have enough visible external surface(s) so as to potentially be used to display content (e.g., whether it is commercial content, such as marks, logos, or advertising, whether it is artistic depictions, such as drawings, patterns, or colors, or whether it is school colors, emblems, or the like).

A hardscape torch may be marketed to homeowners, renters, businesses, or anyone who is looking to improve their landscape/hardscape in particular, but could also be of interest to home improvement stores, garden centers, and retail stores. One's backyard may be turned into a resort with this unique landscape feature, and can therefore be used as an exotic way to entertain by lighting backyard festivities. The hardscape torches of the present invention can be sold or marketed as individual products or in sets (e.g., sets of two or four, etc.). The hardscape torches may also be marketed individually or as a network of torches that can be used in a public or commercial setting (e.g., hotels, resorts, theaters, museums, recreation centers, malls, parks, etc.). By way of example, a network of hardscape torches may provide or build upon a theme for a recreational park or an amusement park attraction.

In yet a further embodiment of the present invention, the hardscape torch has an attachment mechanism coupled to it. The attachment mechanism can be anything capable of attaching the hardscape torch to another object. For example, the attachment mechanism can be used to attach the hardscape torch to the ground or to a pole (e.g., to prevent theft). Alternatively, the attachment mechanism can simply be used as a carrying handle. In a preferred embodiment, the attachment mechanism is designed to be located away from the flame when hardscape torch is in use. The attachment mechanism can be made of metal, plastic, or fabric (e.g., velcro strap, strap with snap button, or strap with button and button hole). Preferably, the attachment mechanism is fire resistant and blends in with the overall design of the hardscape torch.

FIG. 1 is a view of a hardscape torch according to an embodiment of the present invention. FIG. 1 depicts a base 100 in the shape of a rock or stone. Other shapes are within the scope of the invention. As illustrated in FIG. 1, a fuel canister is preferably inserted and resides beneath the surface 110 of a base 100. More preferably, the top of the recessed fuel canister resides at the perimeter of the stone or rock base. A recessed, or partially recessed, fuel canister provides safety benefits (e.g., the fuel canister is unlikely to fall out) and aesthetic benefits (e.g., the rock or stone base looks more natural with the fuel canister recessed or hidden within it) to the hardscape torch.

FIG. 2 is a view of a fuel canister 200 that may be used in the hardscape torch of FIG. 1 according to an embodiment of the present invention.

Referring now to FIG. 3, a system 300 is disclosed for controlling or operating a hardscape torches or torches in accordance with certain embodiments of the present invention. As shown therein, a personal computing device 310, hardscape torch or torches 320, and server 330 are connected to a network 390. Each of these devices may be configured to communicate via wired or wireless links, or a combination of the two. Each of these devices may also include one or more processors (e.g., central processing units) and/or one or more non-transitory computer storage devices (e.g., RAM, ROM, PROM, SRAM, etc.), which can be configured to control or operate the hardscape torch or hardscape torches. The network 390 may be any type of network such as one that includes the Internet, a local area network (LAN), a wide area network (WAN), an intranet, etc.

A user 305 may operate the personal computing device 310 to communicate directly or indirectly with the hardscape torch or torches 320 for the purpose of controlling or operating them. The hardscape torch 320 may represent any hardscape torch that is capable of being controlled or operated by the personal computing device 310 and/or server 330.

Further, the personal computing device 310 may represent a desktop computer, laptop computer, mobile phone, smartphone, tablet device, or other type of computing device. The personal computing device 310 may include a display and one or more input devices (e.g., keyboard, microphone, camera, video camera, scanner, joystick, remote control device, etc). The personal computing device 310 may also include a web browser. Thus, the personal computing device 310 can be, for example, any one of mobile devices (e.g., an iPhone, Android device or Blackberry), televisions (e.g., applications for NetTV, Google TV device, Apple TV device, or particular televisions such as Samsung 8000 Smart TV), kiosks, desktop computers, or computing devices that provide access to applications in cars, planes, or other vehicles.

In certain embodiments, the server 330 may be stored on a computer storage medium provided by the personal computing device 310 or the server itself 330. The server 330 may represent one or more mainframe computing devices that execute a web server or other type of computing device. In certain other embodiments, the server 330 is coupled to the network 390, the server 330 being adapted to communicate with the personal computing device 310 and at least one of the plurality of hardscape torches 320.

It should be noted that the system in FIG. 3 is merely meant to demonstrate an embodiment of an operating environment that can be utilized in conjunction with the principles disclosed herein, and should not be construed as limiting in any manner whatsoever. The particular configuration in FIG. 3 can be altered in numerous ways without departing from the principles herein.

For example, the manner in which the personal computing device 310 interacts with the server 330 and the network 390 may vary depending on the user 305. In certain embodiments, rather than making an application for controlling or operating a hardscape torch or torches 320 accessible to a user 305 over a network 390, the application for controlling or operating the hardscape torch or torches may represent an application that resides on the personal computing device 310 being operated by the user 305. In such embodiments, the application for controlling or operating the hardscape torch or torches residing on the personal computing device 310 may directly access websites or other information directly or indirectly from the network 390 or server 330. Thus, any functionality of the network 390 which is described herein can alternatively be implemented by a personal computing device 310.

Moreover, in certain embodiments, it may not be necessary to control or operate the hardscape torch or torches over a network 390. For example, a personal computing device 310 may store website files or website content directly on the personal computing device 310, or such may be obtained form a external storage medium (e.g., CD, DVD, USB flash drive, external hard drive, etc.) or server 330.

Even further, although it may be preferable to have one or more hardscape torches 320 connected to the server 330 in order to control or operate the hardscape torch or torches 320, it is not necessary for the hardscape torch or torches 320 to be connected to the server 330. The application for controlling or operating the hardscape torch or torches may be transferred to the hardscape torch or torches 320 or the personal computing device 310 in other ways (e.g., by downloading or storing the application on an external storage medium and utilizing the storage medium to transfer the application or instructions provided by the application to the hardscape torch or torches 320 and/or the personal computing device 310).

In other words, 310 can be a computer, smartphone, and/or tablet programmed to control the one or more hardscape torches 320. It may do so through a network 390 or through a centralized server 330, which can be local or remote or may do so directly by interfacing will each hardscape torch 320.

It should be noted that the system in FIG. 3 is merely meant to demonstrate an embodiment of an operating environment that can be utilized in conjunction with the principles disclosed herein, and should not be construed as limiting in any manner whatsoever. The particular configuration in FIG. 3 can be altered in numerous ways without departing from the principles herein.

Although the invention has been described with reference to specific embodiments, it will be understood by those skilled in the art that various changes may be made without departing from the spirit or scope of the invention. Various examples of such changes have been given in the foregoing description. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the hardscape torch lighting mechanism (e.g., flame) discussed herein may be implemented in a variety of embodiments, and that the foregoing discussion of certain of these embodiments does not necessarily represent a complete description of all possible embodiments. Rather, the detailed description of the invention, and the drawings themselves, disclose at least one preferred embodiment of the invention, and may disclose alternative embodiments of the invention. As another example, the hardscape torch can include multiple lights or flames. As a further example, the lights or flames can be located only at a perimeter of the hardscape torch, partially at the perimeter and partially elsewhere on the hardscape torch (e.g., within the hardscape torch), or at the entire perimeter. As an additional example, the lights or flames on the hardscape torch can be different colors (either the flame or light can change colors), or if more than one light or flame is present, then some or all may be different colored lights or flames to provide an even greater ambience.

By way of example, in certain embodiments, coloring agents can be added to the hardscape torch, e.g., to the fuel or the wick, to provide a vibrant color such as red, blue, green, yellow, purple, etc. to the flame. The types of coloring agents that can be used in the wick of the present invention include barium salt, barium carbonate, barium nitrate, barium oxalate, copper and copper compounds, copper metal, cooper acetoarscenate, copper carbonate, copper chloride, copper oxides, copper oxychloride, lithium carbonate, sodium salts, strontium salts, strontium carbonate, strontium oxalate, and strontium nitrate. Various color enhancers can also be used in the wick of the present invention to produce a colored flame, such as calcium oxalate, hexachlorobenzene, parlon, polyvinylchloride, and saran. Various coloring agents can also be added to the fuel of a hardscape torch (e.g., oil or alcohol), such coloring agents include lithium salt or strontium salt, boric acid, borax sodium salt, barium salt, calcium salt, copper salt, potassium salt, cerium salt, cesium salt, and nitromethane.

All elements claimed in any particular claim are essential to the invention claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A hardscape torch comprising:
a stone or rock base,
and a recessed fuel canister for supplying fuel to a flame, wherein the recessed fuel canister is located within the stone or rock base, such that when inserted into the base, the recessed fuel canister does not protrude from the surface of the base.

2. The hardscape torch of claim 1, wherein the stone or rock base comprises faux material.

3. The hardscape torch of claim 1, wherein the stone or rock base comprises ceramic, masonry, cement, fiberboard, fiberglass, plastic, or metal.

4. The hardscape torch of claim 1, wherein the top of the recessed fuel canister resides at the perimeter of the stone or rock base.

5. The hardscape torch of claim 1, wherein the fuel is alcohol.

6. The hardscape torch of claim 5, wherein a coloring agent is added to the fuel.

7. The hardscape torch of claim 6, wherein the coloring agent is selected from the group consisting of lithium salt, strontium salt, boric acid, borax sodium salt, barium salt, calcium salt, copper salt, potassium salt, cerium salt, cesium salt, and nitromethane.

8. The hardscape torch of claim 1, wherein the hardscape torch is configured to interact with a home automation system.

9. The hardscape torch of claim 8, further comprising timers, sensors, wireless interfaces, or programmable settings.

10. The hardscape torch of claim 1, wherein the fuel comprises an insect repellent.

11. A system comprising:
a personal computing device, and a plurality of hardscape torches each being coupled to a network and comprising
a stone or rock base,
and a recessed fuel canister located within the stone or rock base for supplying fuel to a flame, wherein the plurality of hardscape torches are controllable by the personal computing device through the network.

12. The system of claim 11, wherein the system is a home automation system.

13. The system of claim 11, wherein the system further comprises a processor configured to control at least one of the plurality of hardscape torches.

14. The system of claim 11, wherein the system is configured to operate through wireless links.

15. The system of claim 11, wherein at least one of the plurality of hardscape torches further comprises timers, sensors, wireless interfaces, or programmable settings.

16. The system of claim 11, further comprising a server coupled to the network, the server being adapted to communicate with the personal computing device and at least one of the plurality of hardscape torches.

17. A hardscape torch comprising:
a stone or rock tabletop base,
and a recessed fuel canister for supplying fuel to a flame, wherein the recessed fuel canister is located within the stone or rock base.

18. A method of using a hardscape torch with a home automation system comprising the steps of:
configuring the home automation system to operate the hardscape torch;
igniting the hardscape torch through operation of the home automation system; and
shutting off the hardscape torch through operation of the home automation system.

19. A method according to claim 18, wherein the hardscape torch further comprises an igniter.

20. A method according to claim 18, wherein the hardscape torch further comprises a shut-off switch to shut off a fuel supply for the hardscape torch.
